(19) United States
(12) Patent Application Publication
(10) Pub. No.: US 2005/0186027 A1
(43) Pub. Date: Aug. 25, 2005

(54) Fastener with locking function

(76) Inventor: Jong Shin Kang, Choongchungnam-Do (KR)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/844,383

(22) Filed: May 13, 2004

(30) Foreign Application Priority Data
Feb. 19, 2004 (KR) 2004-10873

(51) Int. Cl. F16B 21/07

(52) U.S. Cl. 403/326

(57) ABSTRACT

There is provided a fastener having a key to fasten two separate articles for backpacks or bags carrying personal belongings or valuables or the like, and the fastener includes the fastener includes at least two locking pins installed in the receiving unit and resiliently supported by a biasing member, a key receiving groove formed on a front surface of the receiving unit in a desired depth and having an optional shape, a plurality of locking holes, formed in the inserting unit at a position corresponding to the locking pin, for receiving the locking pin, so that the inserting unit is snapped to the receiving unit, and a key adapted to complementarily match with the key receiving groove formed on the front surface of the receiving unit, and having a permanent magnet displaced at a position corresponding to the locking pin to pull the locking pin from the locking hole. When the inserting unit is inserted into the receiving unit, the locking pin installed in the receiving unit and biased therein by a biasing member is snapped to the locking hole of the inserting unit. A fastening state of the inserting unit is released by inserting the key into the key receiving groove formed on the front surface of the receiving unit.

### BACKGROUND OF THE INVENTION

1. Field of the Invention

The present invention relates to fasteners used in backpacks or bags carrying personal belongings or valuables therein to fasten a cover or opening thereof, and more particularly, to a fastener having a magnetic key.

2. Description of the Related Art

Currently, various types of fasteners have been developed to fasten a cover or opening using a pair of female/male units. For a backpack, a body and a cover are provided with a female-type receiving unit and a male-type inserting unit at opposite positions of the backpack, respectively. The receiving unit and the inserting unit are adapted to complementarily match with each other. The receiving unit and the inserting unit are provided with a resiliently locking piece and a locking protrusion engaged with the locking piece, respectively, so that the units are not unfastened without artificial means to reliably maintain a fastening state of the cover.

Such a fastener has a simple function of adjusting the cover of a backpack to maintain a closed state of the cover and thus prevent the cover from being optionally opened. The fastener is unfastened by pushing directly or indirectly, using a button, the resiliently locking piece of the inserting unit which is protruded outward through the locking protrusion of the receiving unit such that the locking state of the resiliently locking piece is released, as described above. Accordingly, since the fastener is unfastened by a simple pushing operation, it has a poor keeping and protecting function so that personal belongings are frequently stolen.

### SUMMARY OF THE INVENTION

Accordingly, the present invention is directed to a fastener having a key that substantially obviates one or more problems due to limitations and disadvantages of the related art.

An object of the present invention is to provide a fastener having a key capable of improving safekeeping and protection of personal belongings and thus increasing the reliability thereof, in which a male-type inserting unit is snapped by at least two locking pins installed in a female-type receiving unit and resiliently supported by a biasing member, in which the fastener is released by a key adapted to complementarily match with a key receiving groove formed on a front surface of the receiving unit and having a permanent magnet displaced at a position corresponding to the locking pin to pull the locking pin from the locking hole.

Another object of the present invention is to provide a fastener having a key capable of optionally altering the arrangement of a magnet of a key and a locking pin of a receiving unit, thereby providing the key having the infinite number of cases.

Further another object of the present invention is to provide a fastener having a key, in which since the fastener includes an element for pushing out an inserting unit, when the inserting unit is released from a locking pin, the inserting unit is automatically pushed out from a receiving unit, thereby conveniently using the fastener.

To achieve the object and other advantages, according to one aspect of the present invention, there is provided a fastener having a key for backpacks or bags carrying personal belongings or valuables therein to fasten a cover or opening thereof, and the fastener includes a female-type unit and a male-type inserting unit, the fastener comprising: at least two locking pins installed in the receiving unit and resiliently supported by a biasing member; a key receiving groove formed on a front surface of the receiving unit in a desired depth and having an optional shape; a plurality of locking holes, formed in the inserting unit at a position corresponding to the locking pin, for receiving the locking pin, so that the inserting unit is snapped to the receiving unit; and a key adapted to complementarily match with the key receiving groove formed on the front surface of the receiving unit, and having a permanent magnet displaced at a position corresponding to the locking pin to pull the locking pin from the locking hole; wherein when the inserting unit is inserted into the receiving unit, the locking ping installed in the receiving unit and biased therein by a biasing member is snapped to the locking hole of the inserting unit, and wherein a fastening state of the inserting unit is released by inserting the key into the key receiving groove formed on the front surface of the receiving unit.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is an exploded perspective view of a fastener having a key according to one preferred embodiment of the present invention;

FIG. 2 is a top view depicting a fastener including a receiving unit and an inserting unit according to the present invention;

FIG. 3 is an enlarged cross-sectional view taken along a line A-A in FIG. 2;

FIG. 4a is a cross-sectional view depicting a fastening state of a fastener according to the present invention;

FIG. 4b is a cross-sectional view depicting a state in which a fastener of the present invention is released by a key; and

FIG. 5 is a front view of a backpack to which a fastener having a key according to the present invention is applied.

### DETAILED DESCRIPTION OF THE PREFERRED EMBODIMENTS

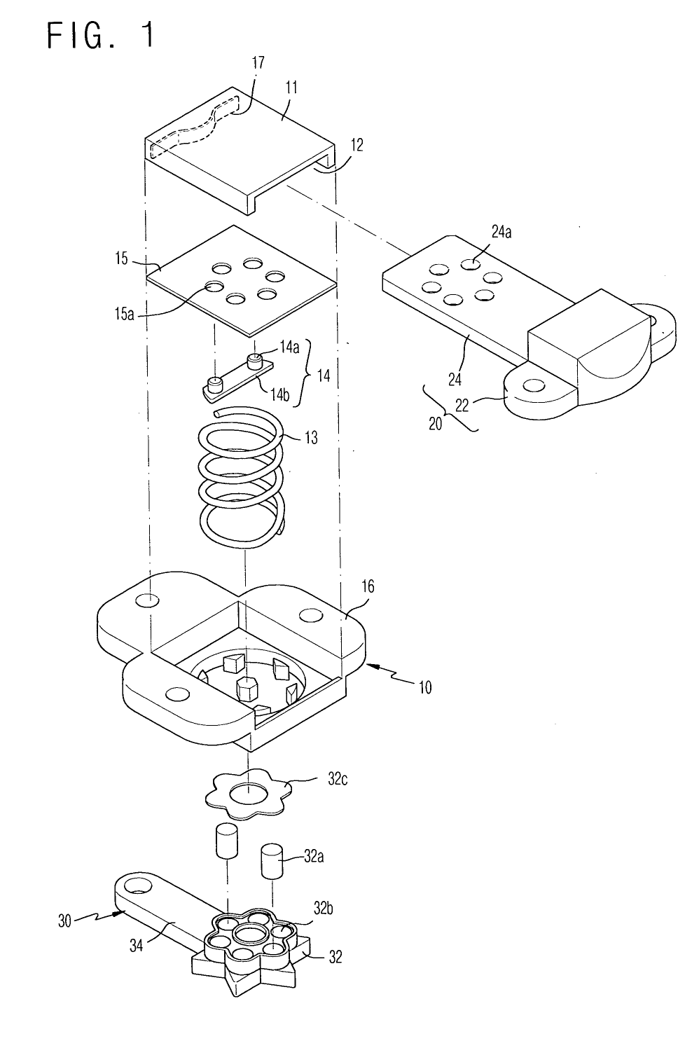

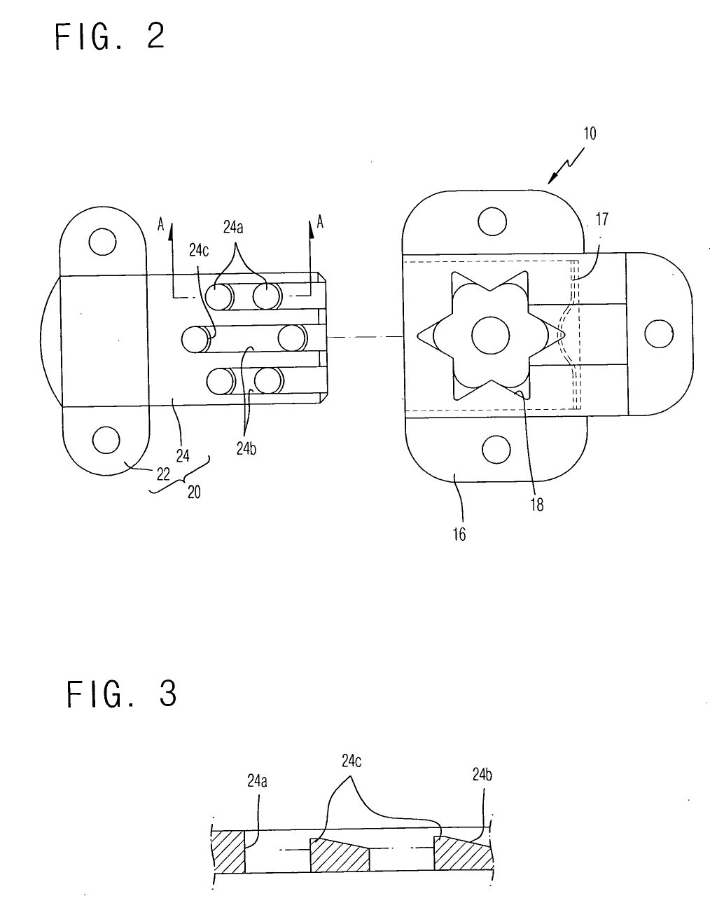

A preferred embodiment according to the present invention will now be explained with reference to the accompanying drawings. FIGS. 1 and 2 show a fastener having a key according to one preferred embodiment of the present invention. The present invention provides an improved fastener used in backpacks or bags carrying personal belongings or valuables therein to fasten a cover or opening thereof

The fastener of the present invention mainly includes a female-type receiving unit 10, a male-type inserting unit 20, and a key 30 for releasing a fastening state of the receiving and inserting units 10 and 20 using magnetic force of a magnet. The receiving and inserting units 10 and 20 configured as described above are respectively installed to opposite sides of an object to be fastened, and are adapted to complementarily match with each other.

The receiving unit 10 has a hollow case body and a separate bottom member 11 engaged to a bottom thereof, so as to form an accommodating space 12 through which the inserting unit 20 freely comes in and out. The inserting unit 20 is inserted into the accommodating space 12, and then is locked with the receiving unit 10 by locking components described below.

Also, the receiving unit 10 has a locking pin 14 resiliently supported by at least two biasing members 13. The locking pin 14 is made of a strip-type metal plate 14a, and bosses 14b are formed on both ends of the metal plate 14a by a drawing process.

The locking pin 14 configured as described above is inserted into or leaved from locking holes of the inserting unit 20 to perform a locking/unlocking function. Although the locking pin 14 has two collinear bosses 14b, three or more bosses 14b may be formed in a triangle shape. The locking pin 14 may have a number of cases in an unlocking condition of the key by altering an arrangement thereof using a guide plate, which will be described below.

The locking pin 14 is arranged by a guide plate 15 with a plurality of through-holes 15a for guiding displacement of the locking pin 14, and the guide plate 15 forms a bottom of the accommodating space 12 of the receiving unit 10. The guide plate 15 is of a flat plate, and the plurality of through-holes 15a are formed in a circular shape on a surface of the guide plate at regular intervals.

Also, the receiving unit 10 has a resilient plate 17 of outstanding restoring force within the accommodating space 12 of the receiving unit 10. The resilient plate 17 is compressed, with the inserting unit 20 being locked. When the inserting unit 20 is unlocked, the resilient plate 17 pushes the inserting unit 20 out of the accommodating space 12 using the restoring force thereof A flange 16 is integrally formed with an outer edge of the receiving unit 10 so that the receiving unit is attached to the article. The receiving unit 10 also has a two-phase key receiving groove 18 on a front surface thereof The key receiving groove 18 is formed on the front surface of the receiving unit 10 in a desired depth, and has a complementary shape adapted to match with a shape of a key 30 for unlocking the inserting unit 20 inserted and locked to the receiving unit 10. The key receiving groove 18 may have various shapes according to the shape of the key 30. Accordingly, in the case where the key receiving groove 18 matches with the key 30 in shape, the key can be inserted into the key receiving groove to improve the protection.

The inserting unit 20 includes a handle portion 22 gripped by a hand of a user when the user operates the fastener, and a plate-type plug 24 inserted into or released from the accommodating space 12 of the accommodating unit 10. The plug 24 is engaged with the receiving unit 10, with the bosses of the locking pin 14 being inserted into locking holes of the plug.

The plug 24 is formed in a circular shape with a plurality of locking holes 24a at regular intervals. The bosses 14a of the locking pin 14 are inserted into the locking holes so that the inserting unit 20 is snapped by the receiving unit 10. The locking holes 24a are used not in all but in part. The circular arrangement of the locking holes 24a at regular intervals is to accommodate the alteration of the locking pin 14 by the guide plate 15, as described above.

The locking holes 24a of the plug 24 of the inserting unit 20 are provided with rails 24b for guiding the locking pin 14 in the same direction as an inserting direction of the inserting unit 20, as shown in FIG. 3. Also, the locking holes 24a are provided with one-way protruded portions 24c at front edges of the holes 24a opposite to the rails 24b. The protruded portion 24c has a desired gradient gradually increased from a front side to a rear side. When the inserting unit 20 is fastened to the receiving unit 10, the fastening state is not easily released by the protruded portions 24c.

The key 30 has a head 32 and a knob 34, and the head 32 is of a shape corresponding to the shape of the key receiving groove 18 of the receiving unit 10. The head 32 may be formed in two or more phase to complicate the matching shape and thus increase the number of cases.

In addition, the head 32 is formed with a plurality of magnet receiving holes 32b for receiving a magnet 32a selectively displaced at a position corresponding to the arrangement of the locking pin 14 of the receiving unit 10. The magnet receiving holes 32b is covered by a non-magnetic cover 32c, with the magnet 32a being embedded in the selected hole 32b. Magnetic force of the magnet 32a surpasses the biasing force of the biasing member 13 of the receiving unit 10.

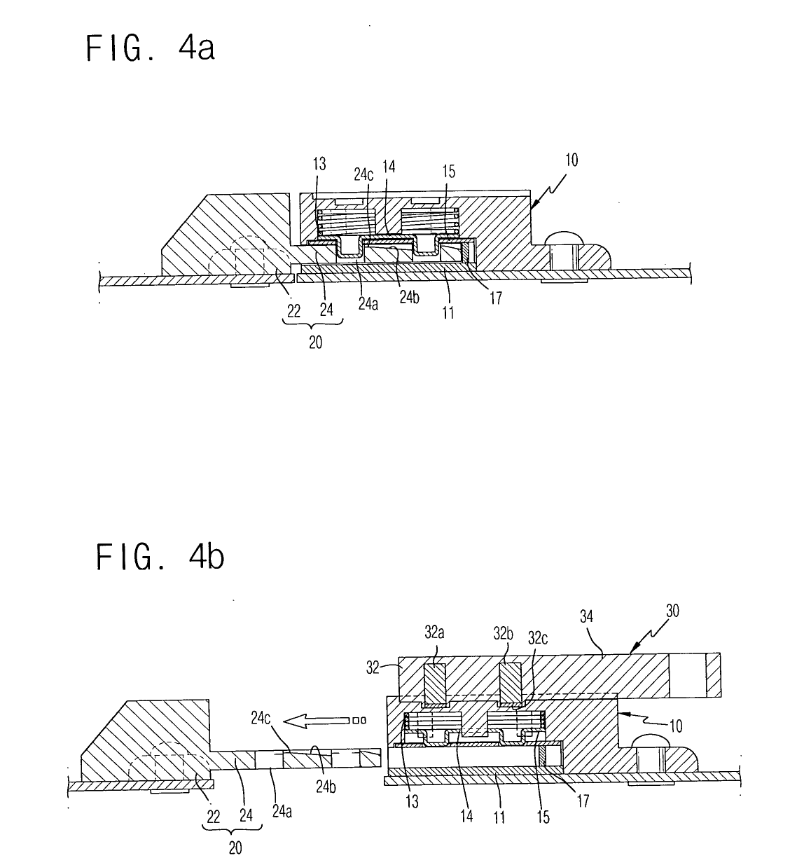

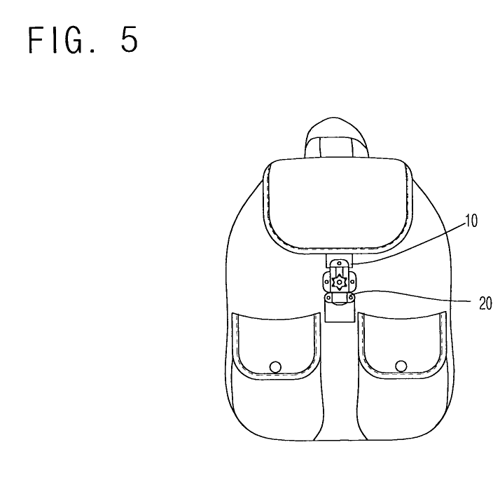

Locking/unlocking operation of the fastener having the magnetic key according to one preferred embodiment of the present invention will now be described with reference to FIGS. 4a and 4b.

FIG. 4a shows the fastening state of the fastener. Specifically, if the plug 24 of the inserting unit 20 is inserted into the accommodating space 20 of the receiving unit 10, the bosses 14a of the locking pin 14 which are protruded into the accommodating space 12 by the biasing force of the biasing member 13 through the through-holes 15a of the guide plate 15 of the receiving unit 10 are temporarily pushed down by the inserting force of the plug 24. Then, when the bosses 14a coincide with the locking holes 24a provided to the plug 24 of the inserting unit 20, the bosses 14a are pushed up by the biasing force of the biasing member 30. Accordingly, the inserting unit 20 is snapped to the receiving unit 10 by the locking pin 14, thereby maintaining the fastening state of the faster.

FIG. 4b shows a state in which the fastener is released by the key. Specifically, the head 32 of the key 30 is inserted into the key receiving groove 18 provided to the front surface of the receiving unit 10 in the complementary manner.

If the insertion of the head 32 of the key 30 into the key receiving groove 18 is completed, the locking pin 14 inserted into the locking hole 24a of the inserting unit 20 is released from the locking hole 24a by the magnetic force of the magnets 32a displaced at the position corresponding to the arrangement of the locking pin 14 of the receiving unit 10. At the same time, the inserting unit 20 is pushed out from the accommodating space 12 of the receiving unit 10 by the biasing force of the biasing member 17 which is compressed in the accommodating space 12, thereby releasing the fastener.

With the above description, the fastener having the key according to the present invention has an improved safekeeping and protection of personal belongings, thereby increasing the reliability.

The present invention optionally alters the arrangement of the magnet in the key and the locking pin of the receiving unit, thereby providing the key having the infinite number of cases.

In addition, since the present invention includes an element for pushing out inside the receiving unit, when the inserting unit is released from the locking pin, the inserting unit is automatically pushed out from the receiving unit, thereby conveniently using the fastener.

The foregoing embodiment is merely exemplary and is not to be construed as limiting the present invention. The present teachings can be readily applied to other types of apparatus. The description of the present invention is intended to be illustrative, and not to limit the scope of the claims. Many alternatives, modifications, and variations will be apparent to those skilled in the art.

1. A fastener comprising a female-type receiving unit and a male-type inserting unit to fasten two separate articles for backpacks or bags carrying personal belongings or valuables or the like, the fastener further comprising:
at least two locking pins installed in the receiving unit and resiliently supported by a biasing member;
a key receiving groove formed on a front surface of the receiving unit in a desired depth and having an optional shape;
a plurality of locking holes, formed in the inserting unit at a position corresponding to the locking pin, for receiving the locking pin, so that the inserting unit is snapped to the receiving unit; and
a key adapted to complementarily match with the key receiving groove formed on the front surface of the receiving unit, and having a permanent magnet displaced at a position corresponding to the locking pin to pull the locking pin from the locking hole;
wherein when the inserting unit is inserted into the receiving unit, the locking pin installed in the receiving unit and biased therein by a biasing member is snapped to the locking hole of the inserting unit, and wherein a fastening state of the inserting unit is released by inserting the key into the key receiving groove formed on the front surface of the receiving unit.

2. The fastener as claimed in claim 1, wherein the locking pin has at least two bosses formed on both ends of a plate having a desired length, and the bosses are inserted into or released from the locking holes of the inserting unit.

3. The fastener as claimed in claim 1, further comprising a guide plate positioned between the inserting unit and the locking pin in the receiving unit for guiding the locking pin.

4. The fastener as claimed in claim 1, further comprising a resilient plate installed in the receiving unit for pushing the inserting unit out of the receiving unit when a fastening state of the inserting unit is released.

5. The fastener as claimed in claim 1, wherein the locking holes of the inserting unit are provided with rails for guiding the locking pin in the same direction as an inserting direction of the inserting unit.

6. The fastener as claimed in claim 5, wherein the locking holes are provided with one-way protruded portions at front edges of the holes opposite to the rails, and the protruded portion has a desired gradient gradually increased from a front side to a rear side.

7. The fastener as claimed in claim 1, wherein the key has a head and a knob, and the head is of a shape conditionally corresponding to a shape of the key receiving groove of the receiving unit.

8. The fastener as claimed in claim 7, wherein the head is formed with a plurality of magnet receiving holes for optionally receiving a magnet which is to pull the locking pin from the locking hole of the inserting unit.
